(19) United States
(12) Patent Application Publication
(10) Pub. No.: US 2015/0375602 A1
(43) Pub. Date: Dec. 31, 2015

(54) Air Filtration Assembly

(71) Applicant: Gerald A. Fields, Noble, OK (US)

(72) Inventor: Gerald A. Fields, Noble, OK (US)

(21) Appl. No.: 14/317,350

(22) Filed: Jun. 27, 2014

(51) Int. Cl. B60H 3/06; B01D 46/42; B01D 46/00

(52) U.S. Cl. CPC B60H 3/06; B01D 46/0023; B01D 46/4245

(57) ABSTRACT

An air filtration assembly for filtering air in a vehicle includes a housing that may be positionable within a vehicle. A first filter is coupled to the housing. A second filter is coupled to the housing. The second filter comprises a plurality of filtering mediums. A motor is coupled to the housing. A fan is coupled to the motor. The motor moves the fan. The fan urges air through the first and second filters so particles in the air in the vehicle are filtered.

### BACKGROUND OF THE DISCLOSURE

### Field of the Disclosure

The disclosure relates to filtration devices and more particularly pertains to a new filtration device for filtering air in a vehicle.

### SUMMARY OF THE DISCLOSURE

An embodiment of the disclosure meets the needs presented above by generally comprising a housing that may be positionable within a vehicle. A first filter is coupled to the housing. A second filter is coupled to the housing. The second filter comprises a plurality of filtering mediums. A motor is coupled to the housing. A fan is coupled to the motor. The motor moves the fan. The fan urges air through the first and second filters so particles in the air in the vehicle are filtered.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a air filtration assembly ac power cording to an embodiment of the disclosure.

FIG. 2 is a top perspective view of an embodiment of the disclosure.

FIG. 3 is a cross sectional view taken along line 3-3 of FIG. 1 of an embodiment of the disclosure.

FIG. 4 is a bottom view of an embodiment of the disclosure.

FIG. 5 is an in-use view of an embodiment of the disclosure.

FIG. 6 is an in-use view of an alternative embodiment of the disclosure.

### DESCRIPTION OF THE PREFERRED EMBODIMENT

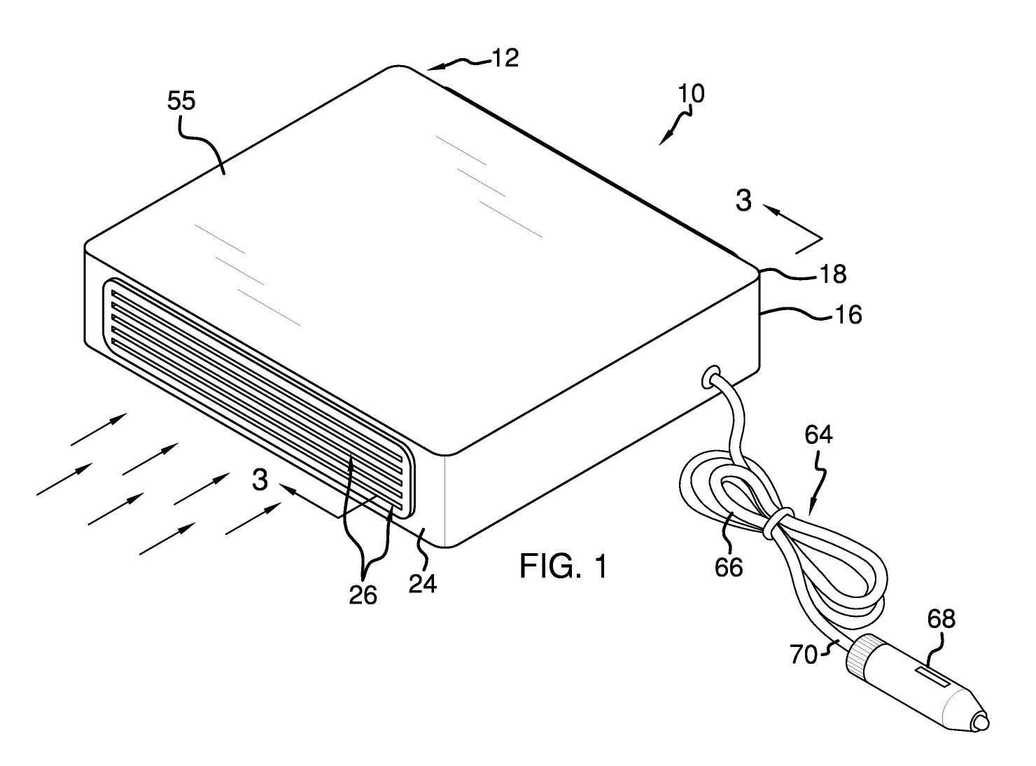

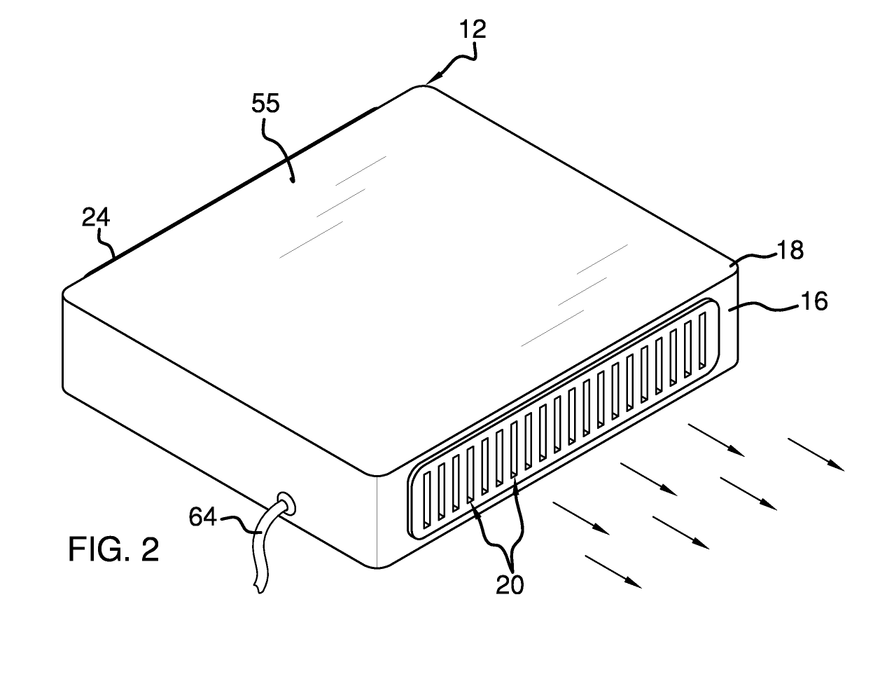

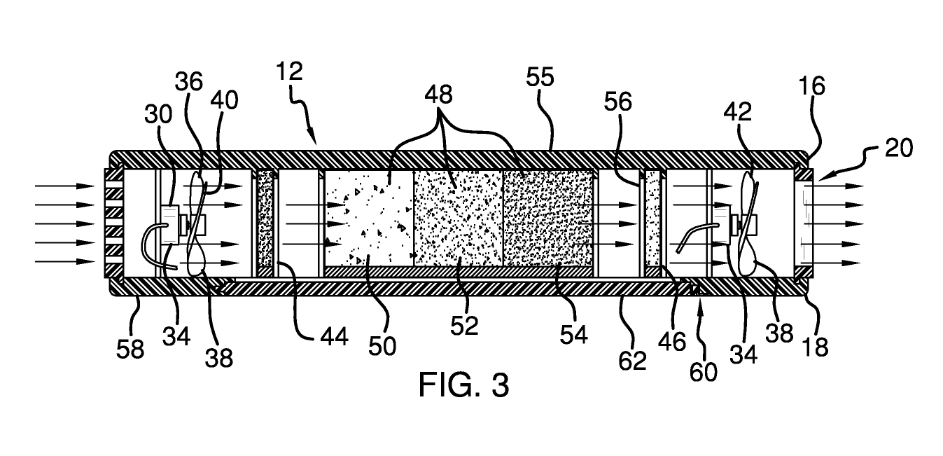

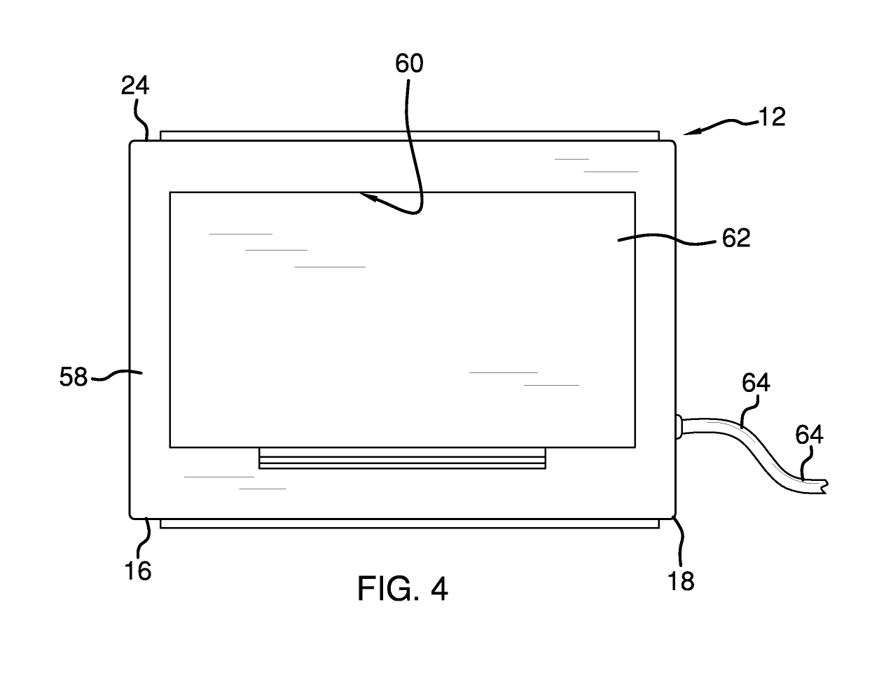

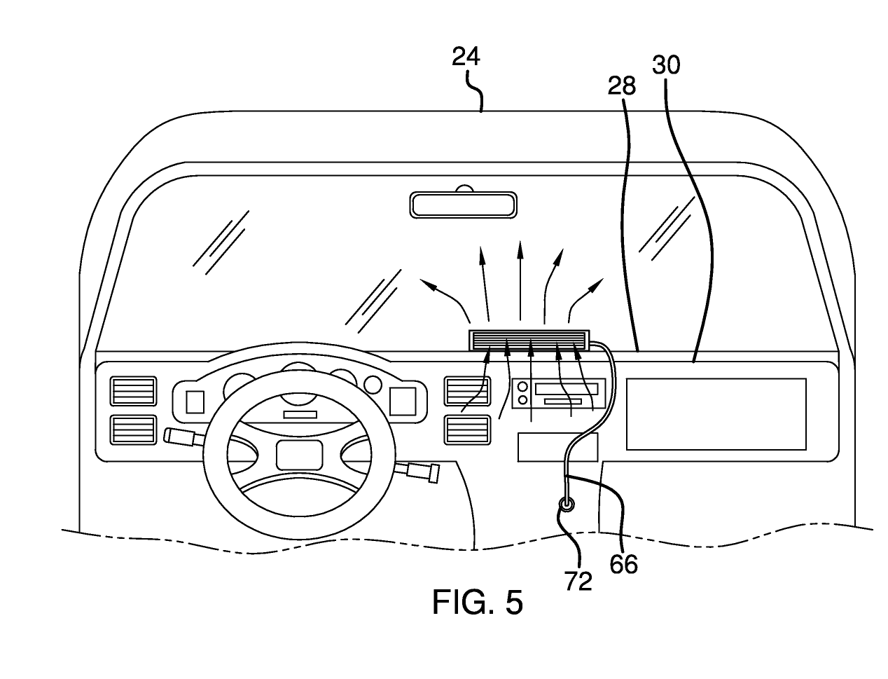

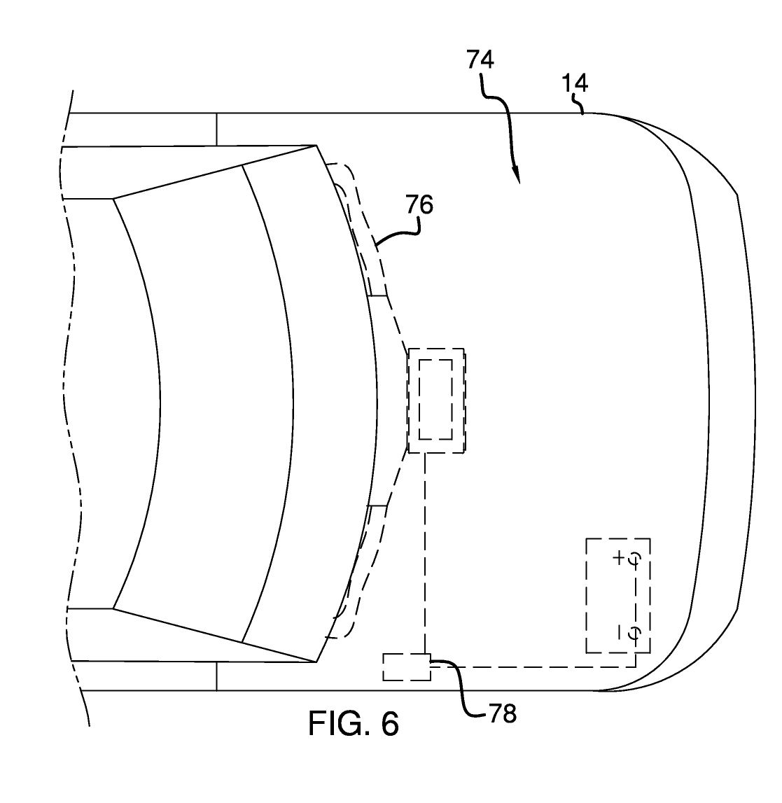

With reference now to the drawings, and in particular to FIGS. 1 through 6 thereof, a new filtration device embodying the principles and concepts of an embodiment of the disclosure and generally designated by the reference numeral 10 will be described.

As best illustrated in FIGS. 1 through 6, the air filtration assembly 10 generally comprises a housing 12 that may be positionable within a vehicle 14. A front side 16 of an outer wall 18 of the housing 12 has a plurality of exhaust vents 20 extending therethrough. The plurality of exhaust vents 20 extends between a first lateral side 22 and a second lateral side 24 of the outer wall 18 of the housing 12. A back side 24 of the outer wall 18 of the housing 12 has a plurality of intake vents 26 extending therethrough. The plurality of intake vents 26 extends between the first 22 and second 24 lateral sides of the outer wall 18 of the housing 12. The housing 12 is positionable on a top 28 of a dashboard 30 in the vehicle 14. The vehicle 14 may be a passenger vehicle of any conventional design.

A motor 32 is coupled to the housing 12. The motor 32 may be an electrical motor of any conventional design. The motor 32 is one of a pair of the motors 34. Each of the pair of motors 34 is positioned proximate an associated one of the intake 20 and exhaust 26 vents.

A fan 36 is rotatably coupled to the motor 32. The fan 36 is one of a pair of the fans 38. Each of the pair of fans 38 is rotatably coupled to an associated one of the pair of motors 34. A first one 40 of the pair of fans 38 urges air inwardly through the intake vent 20. A second one 42 of the pair of fans 38 urges air outwardly through the exhaust vent 26.

A first filter 44 is removably coupled to the housing 12. The first filter 44 is positioned proximate the first fan 40. The first fan 40 urges air through the first filter 44 such that particles in the air are filtered. The first filter 44 may comprise a disposable foam filter of any conventional design.

A second filter 46 is removably coupled to the housing 12. The second filter 46 is positioned between the first filter 44 and the second fan 42. The second fan 42 urges air through the second filter 46 so particles in the air are filtered. The second filter 46 comprises a plurality of filtering mediums 48.

A first one 50 of the plurality of filtering mediums 48 of the second filter 46 may comprise a HEPA filter of any conventional design. A second one 52 of the plurality of filtering mediums 48 of the second filter 46 may comprise an Ionic filter of any conventional design. Lastly, a third one 54 of the plurality of filtering mediums 48 may comprise an Activated Carbon filter of any conventional design.

A third filter 56 is provided. The third filter 56 is removably coupled to the housing 12. The third filter 56 is positioned between the second filter 46 and the second fan 42. The third filter 56 may comprise a scented filter of any conventional design. The third filter 56 imparts a scent to the filtered air. Each of the first 44, second 46 and third 56 filters extends between a top side 55 and a bottom side 58 of the outer wall of the housing.

The bottom side 58 of the outer wall 18 of the housing 12 has a filter opening 60 extending therethrough. Each of the first 44, second 46 and third 56 filters are accessible through the filter opening 60. Additionally, each of the first 44, second 46 and third 56 filters may be replaced after the first 44, second 46 and third 56 filters are depleted. A cover 62 is removably coupled to the bottom side 58 of the outer wall 18 of the housing 12. The cover 62 closes the filter opening 60.

A power supply 64 is coupled to the housing 12. The power supply 64 is electrically coupled to each of the pair of motors 34. The power supply 64 comprises a power cord 66 extending outwardly from the housing 12. A power plug 68 is electrically coupled to a free end 70 of the power cord 66. The power plug 68 is electrically coupled to a cigarette lighter 72 in the vehicle 14.

Alternatively, the housing 12 may be positioned within an engine compartment 74 of the vehicle 12. The exhaust vent 26 on the housing 12 may be fluidly coupled to the vehicle's ventilation system 76. The power supply 64 is electrically coupled to the vehicle's electrical system 78. The assembly 10 may filter air delivered to the vehicle ventilation system 76.

In use, the power plug 68 on the power cord 66 is electrically coupled to the cigarette lighter 72 in the vehicle 14 to actuate the pair of motors 34. The first 44, second 46 and third 56 filters are replaced after each of the first 44, second 46 and third 56 filters become full of particles. In the alternative embodiment, the pair of motors 34 are actuated whenever the vehicle ventilation system 76 is actuated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and ac power cording, all suitable modifications and equivalents may be resorted to, falling within the scope of the disclosure.

I claim:

1. An air filtration assembly configured to filter air in a vehicle, said assembly comprising:
a housing configured to be positionable within the vehicle;
a first filter coupled to said housing;
a second filter coupled to said housing, said second filter comprising a plurality of filtering mediums;
a motor coupled to said housing; and
a fan coupled to said motor such that said motor moves said fan, said fan urging air through said first and second filters such that particles in the air in the vehicle are filtered.

2. The assembly ac power cording to claim 1, further comprising a front side of an outer wall of said housing having a plurality of exhaust vents extending therethrough.

3. The assembly ac power cording to claim 1, further comprising a back side of an outer wall of said housing having a plurality of intake vents extending therethrough.

4. The assembly ac power cording to claim 1, further comprising said motor being one of a pair of said motors.

5. The assembly ac power cording to claim 4, further comprising each of said pair of motors being positioned proximate an associated one of an intake vent and an exhaust vent.

6. The assembly ac power cording to claim 1, further comprising said fan being one of a pair of said fans.

7. The assembly ac power cording to claim 6, further comprising each of said pair of fans being rotatably coupled to an associated one of a pair of said motors.

8. The assembly ac power cording to claim 7, further comprising a first one of said pair of fans urging air inwardly through an intake vent.

9. The assembly ac power cording to claim 7, further comprising a second one of said pair of fans urging air outwardly through an exhaust vent.

10. The assembly ac power cording to claim 1, further comprising said first filter being removably coupled to said housing such that said first filter is positioned proximate a first one of a pair of said fans.

11. The assembly ac power cording to claim 1, further comprising said second filter being removably coupled to said housing such that said second filter is positioned between said first filter and a second one of a pair of said fans.

12. The assembly ac power cording to claim 1, further comprising a power supply coupled to said housing.

13. The assembly ac power cording to claim 12, further comprising said power supply being electrically coupled to each of a pair of said motors.

14. The assembly ac power cording to claim 13, further comprising said power supply comprising a power cord extending outwardly from said housing.

15. The assembly ac power cording to claim 14, further comprising a free end of said power cord being electrically coupled to the vehicle electrical system.

16. An air filtration assembly configured to filter air in a vehicle, said assembly comprising:
a housing configured to be positionable within the vehicle, a front side of an outer wall of said housing having a plurality of exhaust vents extending therethrough, a back side of said outer wall of said housing having a plurality of intake vents extending therethrough;
a motor coupled to said housing;
said motor being one of a pair of said motors;
each of said pair of motors being positioned proximate an associated one of said intake and exhaust vents;
a fan coupled to said motor such that said motor moves said fan;
said fan being one of a pair of said fans;
each of said pair of fans being rotatably coupled to an associated one of said pair of motors;
a first one of said pair of fans urging air inwardly through said intake vent;
a second one of said pair of fans urging air outwardly through said exhaust vent;
a first filter removably coupled to said housing such that said first filter is positioned proximate said first fan, said first fan urging air through said first filter such that particles in the air are filtered;
a second filter removably coupled to said housing such that said second filter is positioned between said first filter and said second fan, said second fan urging air through said second filter such that particles in the air are filtered, said second filter comprising a plurality of filtering mediums; and
a power supply coupled to said housing, said power supply being electrically coupled to each of said pair of motors, said power supply comprising a power cord extending outwardly from said housing, a free end of said power cord being electrically coupled to the vehicle electrical system.
